(19) United States
(12) Patent Application Publication
(10) Pub. No.: US 2018/0267334 A1
(43) Pub. Date: Sep. 20, 2018

(54) OPHTHALMIC LENS AND METHOD FOR MANUFACTURING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/636,541

(22) Filed: Jun. 28, 2017

(30) Foreign Application Priority Data
Mar. 15, 2017 (CN) 201710155164.5

(51) Int. Cl. G02C 7/10; C08J 7/18; C08J 7/04; G02C 7/04; B29D 11/00

(52) U.S. Cl. CPC G02C 7/108; C08J 7/18; C08J 7/042; G02C 7/04; B29D 11/00038; B29K 2077/00; B29D 11/00048; C08J 2357/04; C08J 2400/12; G02C 2202/16; B29D 11/00134

(57) ABSTRACT

A method for manufacturing an ophthalmic lens includes: providing a first precursor and a mold, putting the first precursor in a female die of the mold, exposing the first precursor to ultraviolet radiation, thereby receiving a first gel matrix; the first gel matrix comprising an iris region; providing a colored ink layer, forming the colored ink layer on the iris region, exposing the colored ink layer to ultraviolet radiation to receive a colored film; providing a second precursor and forms the second precursor on the color layer, covering a male die of the mold on the second precursor, exposing the mold to ultraviolet radiation to receive a second gel precursor; the colored film is inset between the first gel matrix and the second gel precursor; and releasing the mold to receive the ophthalmic lens.

### FIELD

The subject matter generally relates to an ophthalmic lens and a method for manufacturing the ophthalmic lens.

### BACKGROUND

For cosmetic purposes, contact lenses having matrixes and one or more colored films printed on the matrixes. However, the colored film may easily fall off from the matrix when in use.

### BRIEF DESCRIPTION OF THE DRAWINGS

Implementations of the present technology will now be described, by way of example only, with reference to the attached figures.

FIG. 1 is a cross-sectional view of an exemplary embodiment of an ophthalmic lens of the present disclosure.

FIG. 2 is a cross-sectional view of another exemplary embodiment of an ophthalmic lens of the present disclosure.

FIG. 3 is a flowchart of an exemplary embodiment of a method for manufacturing an ophthalmic lens.

FIG. 4 is a cross-sectional view of a first gel matrix being formed in the method of FIG. 3.

FIG. 5 is a cross-sectional view showing two colored films being formed on the first gel matrix of FIG. 4.

### DETAILED DESCRIPTION OF EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

The term “comprising,” when utilized, means “including, but not necessarily limited to”; it specifically indicates open-ended inclusion or membership in the so-described combination, group, series and the like.

FIG. 1 illustrates an exemplary embodiment of an ophthalmic lens 100. The ophthalmic lens 100 includes a first gel matrix 10, a second gel matrix 20, and at least one colored film 30. The at least one colored film 30 is sandwiched between the first gel matrix 10 and the second gel matrix 20.

The first gel matrix 10 and the second gel matrix 20 can be made of hydrogel or silicone hydrogel.

In at least one exemplary embodiment, both the first gel matrix 10 and the second gel matrix 20 are made of hydrogel.

The first gel matrix 10 includes a transparent pupil region 11 and an annular iris region 12 surrounding the pupil region 11. The colored film 30 is formed on the iris region 12.

The second gel matrix 20 has a similar structure as the first gel matrix 10.

Each of the first gel matrix 10 and the second gel matrix 20 includes dopamine methacrylamide (DMA, chemical formula:

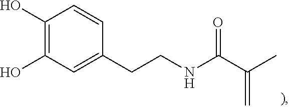 [SMILES: C=C(C)C(=O)NCCc1ccc(O)c(O)c1]

The DMA includes a number of catechol groups.

The colored film 30 includes a number of clay particles 31. The clay particles 31 are dispersed in the colored film 30.

Because DMA further comprises hydroxyl groups (OH—), the hydroxyl groups of the DMA of the first gel matrix 10 can be bonded to the clay particles 31 of the colored film 30 by hydrogen bonding at a connecting interface between the first gel matrix 10 and the colored film 30. Thus, a connecting strength between the first gel matrix 10 and the colored film 30 can be improved.

Similarly, the hydroxyl groups of the DMA of the second gel matrix 20 can be bonded to the clay particles 31 of the colored film 30 by hydrogen bonding at a connecting interface between the second gel matrix 20 and the colored film 30. Thus, a connecting strength between the second gel matrix 20 and the colored film 30 can also be improved.

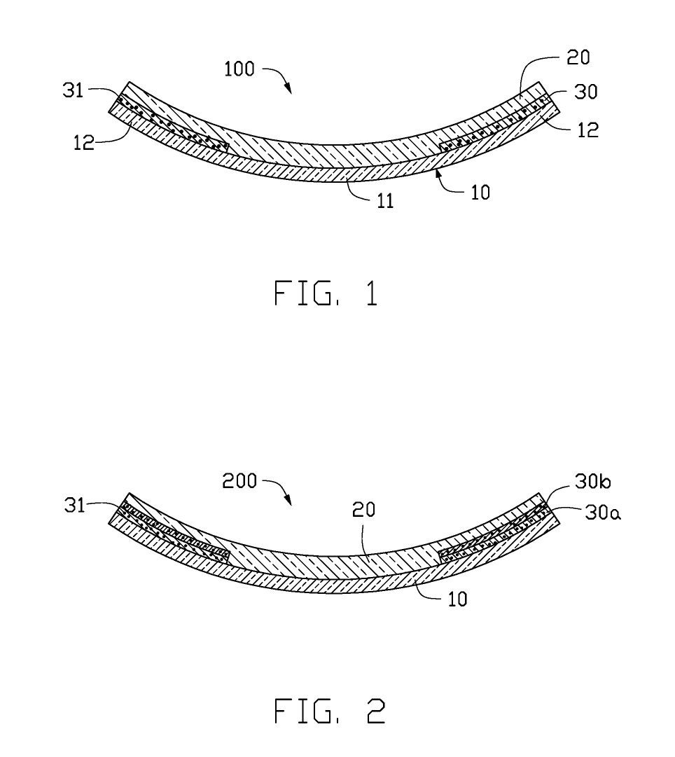

FIG. 2 illustrates another exemplary embodiment of an ophthalmic lens 200. Difference between the ophthalmic lens 200 and the ophthalmic lens 100 is: the ophthalmic lens 200 includes two colored films 30 (hereinafter: “first colored film 30a” and “second colored film 30b”). The first colored film 30a is formed on the iris region 12 of the first gel matrix 10. The second colored film 30b is formed between the first colored film 30a and the second gel matrix 20.

Because DMA further comprises hydroxyl groups (OH—), the hydroxyl groups of the DMA of the first gel matrix 10 can be bonded to the clay particles 31 of the first colored film 30a by hydrogen bonding at a connecting interface between the first gel matrix 10 and the first colored film 30a. Thus, a connecting strength between the first gel matrix 10 and the first colored film 30a can be improved.

At a connecting interface between the first colored film 30a and the second colored film 30b, a diffusion phenomenon happens between grafted chains of the first colored film 30a and grafted chains of the second colored film 30b. Furthermore, the clay particles 31 of the first colored film 30a can be bonded to the clay particles 31 of the second colored film 30b by hydrogen bonding or ionic bonding at the connecting interface between the first colored film 30a and the second colored film 30b. Thus, a connecting strength between the first colored film 30a and the second colored film 30b can be improved.

Because DMA further comprises hydroxyl groups (OH—), the hydroxyl groups of the DMA of the second gel matrix 20 can be bonded to the clay particles 31 of the second colored film 30b by hydrogen bonding at a connecting interface between the second gel matrix 20 and the second colored film 30b. Thus, a connecting strength between the second gel matrix 20 and the second colored film 30b can be improved.

In other exemplary embodiment, the ophthalmic lens can include three or more colored films 30.

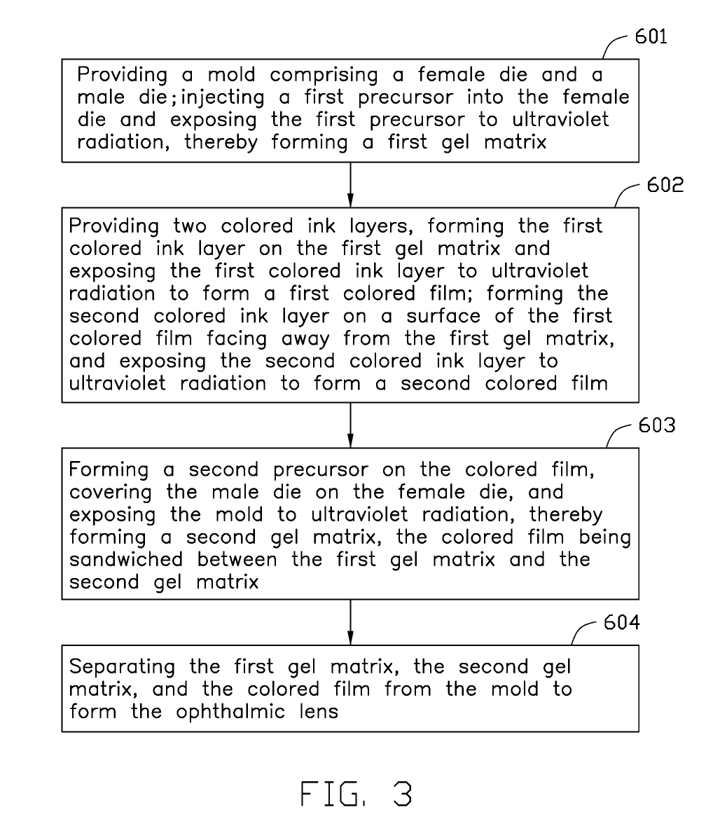

FIG. 3 illustrates a flowchart of a method for manufacturing an ophthalmic lens 200. The method is provided by way of example, as there are a variety of ways to carry out the method. The method described below can be carried out using the configurations illustrated in FIGS. 1-2, for example, and various elements of these figures are referenced in explaining example method. Each block shown in FIG. 3 represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 601.

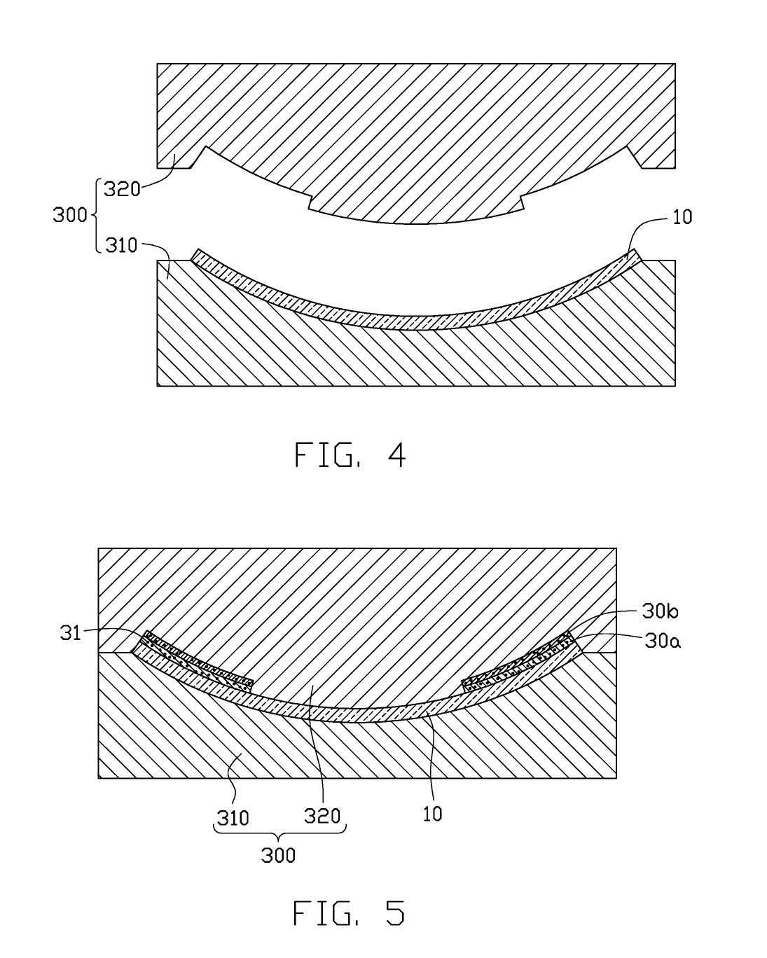

At block 601, a first precursor and a mold 300 are provided. The mold 300 includes a female die 310 and a male die 320. The first precursor is injected into the female die 310 and exposed to ultraviolet radiation, thereby forming the first gel matrix 10, as illustrated by FIG. 4.

In at least one exemplary embodiment, the first precursor is further centrifugated before being exposed to ultraviolet radiation, to form the first gel matrix 10 with a decreased thickness.

The first precursor includes hydrophilic monomers, a cross-linking agent, an initiator, and dopamine methacrylamide (DMA). The hydrophilic monomers, the cross-linking agent, and the initiator undergo a polymerization reaction under the ultraviolet radiation to form a cross-linking network, thereby causing the DMA to be dispersed in the cross-linking network.

In at least one exemplary embodiment, the hydrophilic monomers have a mass percentage of about 88.95% to about 99.49% of a total mass of the first precursor. The cross-linking agent has a mass percentage of about 0.001% to about 1% of the total mass of the first precursor. The initiator has a mass percentage of about 0.005% to about 0.05% of the total mass of the first precursor. The DMA has a mass percentage of about 0.1% to about 10% of the total mass of the first precursor.

The hydrophilic monomers may include methacryloxyalkylsiloxanes, 3-methacryloxypropylpentamethyldisiloxane, bis(methacryloxypropyl)tetramethyl-disiloxane, monomethacrylatedpolydimethylsiloxane, mercapto-terminatedpolydimethylsiloxane, N-[tris(trimethylsiloxy)silylpropyl]acrylamide, N-[tris(trimethylsiloxy)silylpropyl]methacrylamide, tris(pentamethyldisiloxyanyl)-3-methacrylatopropylsilane (T2), 3-methacryloxypropyletris(trimethylsiloxy)silane, 2-hydroxyethylmethacrylate (HEMA), hydroxyethyl acrylate, hydroxypropyl acrylate, hydroxypropyl methacrylate (HPMA), trimethylammonium 2-hydroxy propylmethacrylate hydrochloride, dimethylaminoethyl methacrylate (DMAEMA), dimethylaminoethylmethacrylamide, acrylamide, methacrylamide, allyl alcohol, vinylpyridine, glycerol methacrylate, N-(1,1dimethyl-3-oxobutyl)acrylamide, N-vinyl-2-pyrrolidone (NVP), acrylic acid, methacrylic acid, and N,N-dimethylacrylamide, or any combination thereof.

The cross-linking agent may include ethylene glycol dimethacrylate (EGDMA), trimethylolpropane trimethacrylate (TMPTMA), tri (ethylene glycol) dimethacrylate (TEGDMA), tri(ethylene glycol) divinyl ether (TEGDVE), and trimethylene glycol dimethacrylate, or any combination thereof.

The initiator may be a photoinitiator. The photoinitiator may include benzoin methyl ether, diethoxyacetophenone, a benzoylphosphine oxide initiator, ethyl 2-dimethylaminobenzoate, 2-isopropylthioxanthone, 1-hydroxycyclohexyl phenyl ketone, Darocur type initiator and Irgacur type initiator.

In at least one exemplary embodiment, the photoinitiator includes Darocur-1173, Darocur-2959, and Irgacure-1173, or any combination thereof.

The benzoylphosphine oxide initiator may include 2,4,6-trimethylbenzoyldiphenylophosphine oxide, bis-(2,6-dichlorobenzoyl)-4-N-propylphenylphosphine oxide, and bis-(2,6-dichlorobenzoyl)-4-N-butylphenylphosphine oxide, or any combination thereof.

The first gel matrix 10 includes a transparent pupil region 11 and an annular iris region 12 surrounding the pupil region 11.

At block 602, also illustrated by FIG. 5, two colored ink layers (a first colored ink layer and a second colored ink layer) are provided. The first colored ink layer is formed on the iris region 12 of the first gel matrix 10 and exposed to ultraviolet radiation, thereby forming a first colored film 30a. The second colored ink layer is formed on a surface of the first colored film 30a facing away from the first gel matrix 10 and exposed to ultraviolet radiation, thereby forming a second colored film 30b.

In at least one exemplary embodiment, the two colored ink layers can be respectively formed on the first gel matrix 10 and the first colored film 30a by pad-transfer printing.

In at least one exemplary embodiment, each of the first colored film 30a and the second colored film 30b has a thickness of about 1 μm to about 100 μm.

In at least one exemplary embodiment, the two colored ink layers are exposed to ultraviolet radiation for about 10 seconds to about 5 minutes.

In at least one exemplary embodiment, manufacturing the color ink layer can be carried out by: mixing hydrophilic monomers, a cross-linking agent, an initiator, and a number of clay particles 31 to form a mixture; adding a colorant and a solvent to the mixture to form a colored ink; exposing the colored ink to ultraviolet radiation, which causing the colored ink to be solidified to form the colored ink layer.

In at least one exemplary embodiment, the hydrophilic monomers have a mass percentage of about 42% to about 78% of a total mass of the mixture. The cross-linking agent has a mass percentage of about 10% to about 38% of the total mass of the mixture. The initiator has a mass percentage of about 1% to about 8% of the total mass of the mixture. The clay particles 31 have a mass percentage of about 0.1% to about 15% of the total mass of the mixture.

When exposed to ultraviolet radiation, the hydrophilic monomers, the cross-linking agent, and the initiator undergo a polymerization reaction to form a cross-linking network, thereby causing the clay particles 31 to be dispersed in the cross-linking network.

In at least one exemplary embodiment, the mixture has a mass percentage of about 24% to about 78% of a total mass of the colored ink. The colorant has a mass percentage of about 17% to about 45% of the total mass of the colored ink. The solvent has a mass percentage of about 5% to about 31% of the total mass of the colored ink.

The colorant can include at least one active functional group. The colorant may include C.I. Reactive Blue 19, C.I. Reactive Red 11, C.I. Reactive Yellow 15, and C.I. Reactive Black 5.

The solvent may be water or an organic solvent. The organic solvent may include methyl alcohol, tetrahydrofuran, tripropylene glycol methyl ether, dipropylene glycol methyl ether, ethylene glycol n-butyl ether, diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimethyl ether, polyethylene glycols, polypropylene glycols, ethyl acetate, butyl acetate, amyl acetate, methyl lactate, ethyl lactate, i-propyl lactate, methylene chloride, 2-butanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl, alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, and N-methyl pyrrolidinone, or any combination thereof.

In at least one exemplary embodiment, the clay particles 31 may be made of a material having kaolinite, dickite, halloysite, nacrite, montmorillonite, pyrophyillite, talc, vermiculite, nontronite, and saponite, illite, chlorite, sepiolite, zeolite, attapulgite, and synthetic clay (such as laponite).

The clay particle 31 can be lamellar. The clay particle 31 has a length of about 1 nm to about 1000 nm, and a thickness of about 0.1 nm to about 100 nm.

At block 603, a second precursor is provided and formed on a surface of the second colored film 30b and a surface of the first gel matrix 10 which is not covered by the second colored film 30b (that is, the pupil region 11). The male die 320 is covered on the female die 310 and exposed to ultraviolet radiation, thereby forming a second gel matrix 20, as shown in FIG. 2.

The first colored film 30a and the second colored film 30b are sandwiched between the first gel matrix 10 and the second gel matrix 20.

The second gel matrix 20 has a same composition as the first gel matrix 10.

After being exposed to ultraviolet radiation, the hydrophilic monomers, the cross-linking agent, and the initiator undergo a polymerization reaction to form a cross-linking network, thereby causing the DMA to be dispersed in the cross-linking network.

At block 604, the first gel matrix 10, the second gel matrix 20 and the colored film 30 are separated from the mold, thereby forming the ophthalmic lens 200.

In at least one exemplary embodiment, the ophthalmic lens 200 can be further hydrated to improve a water content.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A method for manufacturing an ophthalmic lens comprising:
providing a mold comprising a female die and a male die;
injecting a first precursor into the female die and exposing the first precursor to ultraviolet radiation, thereby forming a first gel matrix;
providing a first colored ink layer;
forming the first colored ink layer on the first gel matrix and exposing the first colored ink layer to ultraviolet radiation, thereby forming a first colored film;
forming a second precursor on the colored film, covering the male die on the male die, and exposing the mold to ultraviolet radiation, thereby forming a second gel matrix, the first colored film being sandwiched between the first gel matrix and the second gel matrix; and
separating the first gel matrix, the second gel matrix, and the colored film from the mold to form the ophthalmic lens.

2. The method of claim 1, wherein the first precursor comprises hydrophilic monomers, a cross-linking agent, an initiator, and dopamine methacrylamide, the hydrophilic monomer has a mass percentage of about 88.95% to about 99.49% of a total mass of the first precursor, the cross-linking agent has a mass percentage of about 0.001% to about 1% of the total mass of the first precursor, the initiator has a mass percentage of about 0.005% to about 0.05% of the total mass of the first precursor, the dopamine methacrylamide has a mass percentage of about 0.1% to about 10% of the total mass of the first precursor.

3. The method of claim 2, wherein the hydrophilic monomers, the cross-linking agent, and the initiator undergo a polymerization reaction under the ultraviolet radiation to form a cross-linking network, the DMA is dispersed in the cross-linking network.

4. The method of claim 1, wherein the second precursor comprises hydrophilic monomers, a cross-linking agent, an initiator, and dopamine methacrylamide, the hydrophilic monomers have a mass percentage of about 88.95% to about 99.49% of a total mass of the second precursor, the cross-linking agent has a mass percentage of about 0.001% to about 1% of the total mass of the second precursor, the initiator has a mass percentage of about 0.005% to about 0.05% of the total mass of the second precursor, the dopamine methacrylamide has a mass percentage of about 0.1% to about 10% of the total mass of the second precursor.

5. The method of claim 4, wherein the hydrophilic monomers, the cross-linking agent, and the initiator undergo a polymerization reaction under the ultraviolet radiation to form a cross-linking network, the dopamine methacrylamide in the second precursor is dispersed in the cross-linking network.

6. The method of claim 1, wherein the first colored ink layer is formed on the first gel matrix by pad-transfer printing technology.

7. The method of claim 1, wherein the providing the first colored ink layer further comprises:
mixing hydrophilic monomers, a cross-linking agent, an initiator, and clay particles to form a mixture;
adding a colorant and a solvent to the mixture to form a colored ink; and
exposing the colored ink to ultraviolet radiation to form the colored ink layer.

8. The method of claim 7, wherein the hydrophilic monomers have a mass percentage of about 42% to about 78% of a total mass of the mixture, the cross-linking agent has a mass percentage of about 10% to about 38% of the total mass of the mixture, the initiator has a mass percentage of about 1% to about 8% of the total mass of the mixture, the clay particles 31 have a mass percentage of about 0.1% to about 15% of the total mass of the mixture.

9. The method of claim 7, wherein the mixture has a mass percentage of about 24% to about 78% of a total mass of the colored ink, the colorant has a mass percentage of about 17% to about 45% of the total mass of the colored ink, the solvent has a mass percentage of about 5% to about 31% of the total mass of the colored ink.

10. The method of claim 7, wherein the hydrophilic monomers, the cross-linking agent, and the initiator undergo a polymerization reaction to form a cross-linking network, and wherein the clay particles are dispersed in the cross-linking network.

11. The method of claim 1, wherein a thickness of the colored film is about 1 μm to about 100 μm.

12. The method of claim 1, wherein the first colored ink layer is exposed to ultraviolet radiation for about 10 seconds to about 5 minutes.

13. The method of claim 1, before the forming the second precursor on the colored film, further comprising:
providing a second colored ink layer; and
forming the second colored ink layer on a surface of the first colored film facing away from the first gel matrix, and exposing second colored ink layer to ultraviolet radiation to form a second colored film.

14. The method of claim 1, further comprising:
hydrating the ophthalmic lens.

15. An ophthalmic lens comprising:
a first gel matrix;
a second gel matrix; and
at least one colored film sandwiched between the first gel matrix and the second gel matrix.

16. The ophthalmic lens of claim 15, wherein the first gel matrix comprises a transparent pupil region and an annular iris region surrounding the pupil region, and the at least one colored film is formed on the iris region.
